(19) United States
(12) Patent Application Publication
(10) Pub. No.: US 2014/0122226 A1
(43) Pub. Date: May 1, 2014

(54) HYBRID ADVERTISING SUPPORTED AND USER-OWNED CONTENT PRESENTATION

(71) Applicant: MICROSOFT CORPORATION, Redmond, WA (US)

(72) Inventors: Joseph Michael Downing, Redmond, WA (US); Benjamin Alton, Seattle, WA (US); Scott M. Duren, Kirkland, WA (US); Kyunga Lee, Issaquah, WA (US); Leah Dona Hobart, Issaquah, WA (US)

(21) Appl. No.: 13/887,138

(22) Filed: May 3, 2013

Related U.S. Application Data
(60) Provisional application No. 61/718,621, filed on Oct. 25, 2012.

(51) Int. Cl. G06Q 30/02

(52) U.S. Cl. CPC G06Q 30/0251
USPC 705/14.49

(57) ABSTRACT

A computer implemented method and media performance apparatus. Content items include user owned content and advertising supported content. A determination is made as to whether a next content item for presentation is an advertising supported content item or a user-owned content item. The content item is present if the next content item for presentation is a user-owned content item, and, if not, add to a count if the next content item is an advertising supported content item. An advertisement is presented prior to performing any next advertising supported content item when the count reaches a threshold number.

### CLAIM OF PRIORITY

This application claims the benefit of U.S. Provisional Application 61/718,621, HYBRID ADVERTISING SUPPORTED AND USER-OWNED CONTENT PRESENTATION, filed on Oct. 25, 2012, incorporated herein by reference in its entirety.

### BACKGROUND

Various online music services allow users access to content which the user does not own in return for requiring the user to listen to advertising content. A difference between online music services and early radio is that device based music players which connect to music services have access to both user owned content and streaming content from services. Generally, the music service provides a dedicated application or web site to provide the service and the user is captured in the service's application and subject to the services requirements regarding advertising.

### SUMMARY

The technology, roughly described, includes a computer implemented presentation application which allows content consumption of user owned and advertising-supported content. Users are presented with advertisements for advertising supported content, but not presented with advertising for user owned content. Any number of different content types may be utilized in accordance with the technology.

The technology includes a computer implemented method and media performance apparatus. The apparatus can include an audio/visual output and a processor presenting user-owned and advertising supported content to the output. Code instructs the processor to present items of user owned content and advertising supported content to the audio/visual output. The code instructs the processor to determine whether a next content item for presentation is an advertising supported content item or a user-owned content item. Next, the code instructs the processor to present the content item if the next content item for presentation is a user-owned content item, and add the item to a count if the next content item is an advertising supported content item. An advertisement is presented prior to performing any next advertising supported content item when the count reaches a threshold number.

### BRIEF DESCRIPTION OF THE DRAWINGS

FIG. 1 is a depiction of a service and a client comprising a system suitable for implementing the present technology.

FIG. 2A is a flowchart illustrating a method for impression optimization of audio and video ads in a mixed local and ad supported content stream.

FIG. 2B is a flowchart illustrating a method for impression optimization of audio and video ads in a mixed local and ad supported content stream.

FIG. 3A represents a flowchart to determine whether to play an ad if a playlist or DJ service is active.

FIG. 3B illustrates a method for playing an audio or a visual ad when an edge case occurs.

FIG. 4 is a depiction of a playlist sequence including both user owned and ad supported content.

FIG. 5 is a depiction of a processing unit including a multimedia console.

FIG. 6 is a depiction of a processing unit including a computer system.

FIG. 7 is a depiction of a processing system comprising a mobile or a tablet device.

### DETAILED DESCRIPTION

The technology described herein provides a media presentation service and application with support for both streaming media and local media, and both user owned media and advertisement-supported media. Streaming media can be user owned media or media, which is advertisement supported. Local media is media which is stored on a user's hard drive or stored on a local network, and which is owned by a user.

In the unique aspect of the technology, a presentation application allows content consumption where users are presented with advertisements for advertising supported content, but not presented with advertising for user owned content. In the context of this disclosure, the content will be described as media, and specifically audio media. However, any number of different content types may be utilized in accordance with the technology.

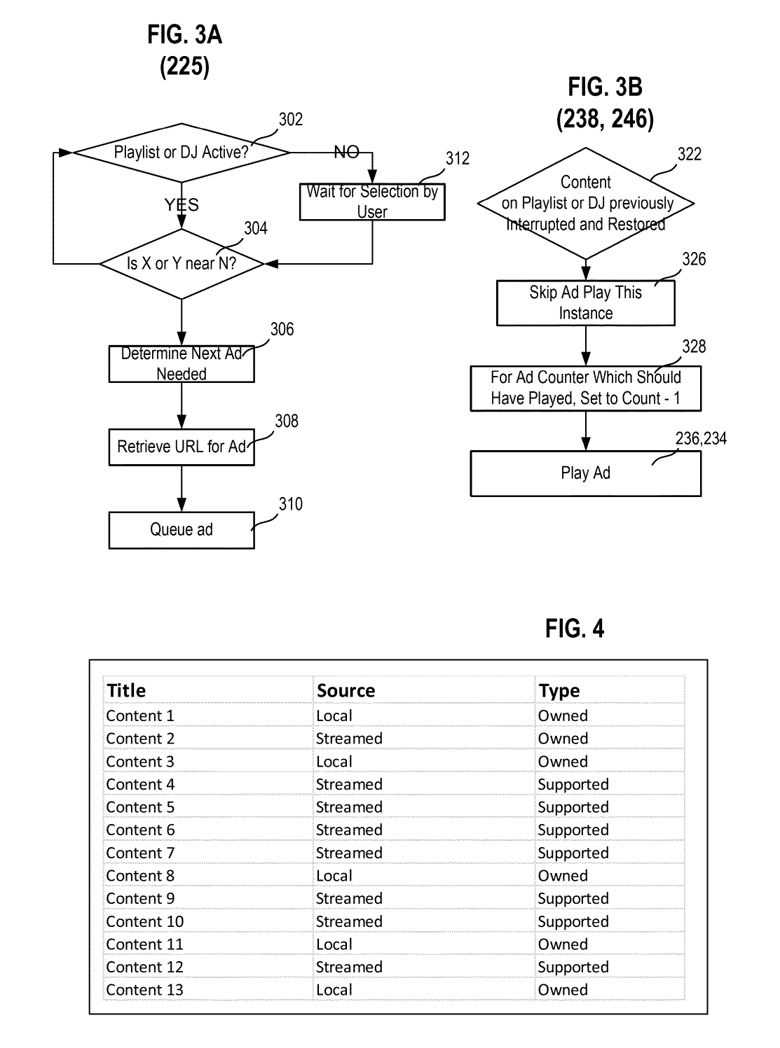

In accordance with the technology, if a user consumes only user owned media, no advertising is presented to the user by the content presentation application. The present technology uses an advertising presentation mechanism which allows the technology to present an advertisement before each individual media segments (songs) in an advertising supported media stream in rendered, and after reaching a specific threshold of advertising supported plays. In one example, no ad will be played if local, user owned content is only presented. This includes local content which is specifically selected by a user to be played in a content presentation application, or which is on a playlist such as that illustrated in FIG. 4.

The technology allows for: the provision of mixed owned and ad supported content in playlists and in the playback experience; the detection of owned and purchased content versus ad supported content; the insertion of audio and video advertising in advertising support content; the insertion of video ads at times and in instances when it is generally known that a user will be present before the interface of a client device; and the prevention of ads being played before the rendering of purchased or owned content.

Where a playlist is used, a content presentation application 114 keeps track of the current position in the list and knows what content is about to be rendered as well as which content or media item will play next. When it is time to play a new media items, an advertising module 116 can return an advertisement as necessary to the content presentation application 114. The content presentation application allows the current track to continue playing (if one exists) and then inserts the audio or video advertisement before playing the next track. If no playlist is present, and the user invokes a content presentation directly, the content presentation application 114 will request instructions from the advertising module 116 as to whether or not to play an advertisement and what type of ad to play.

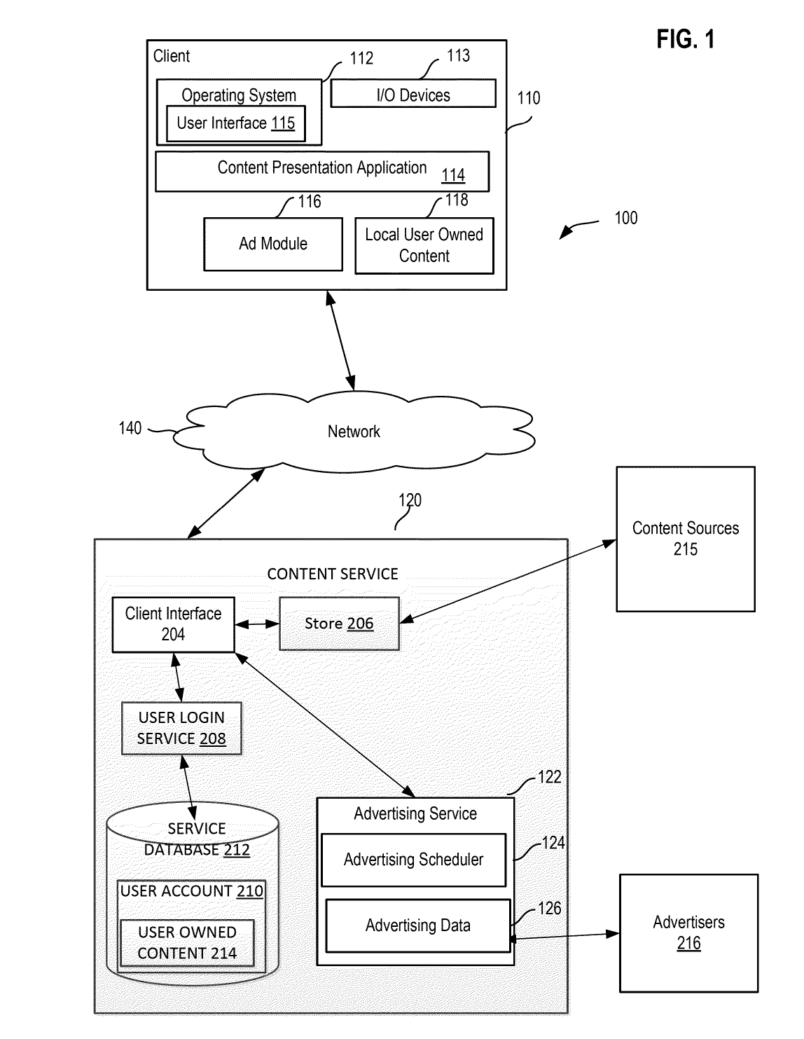

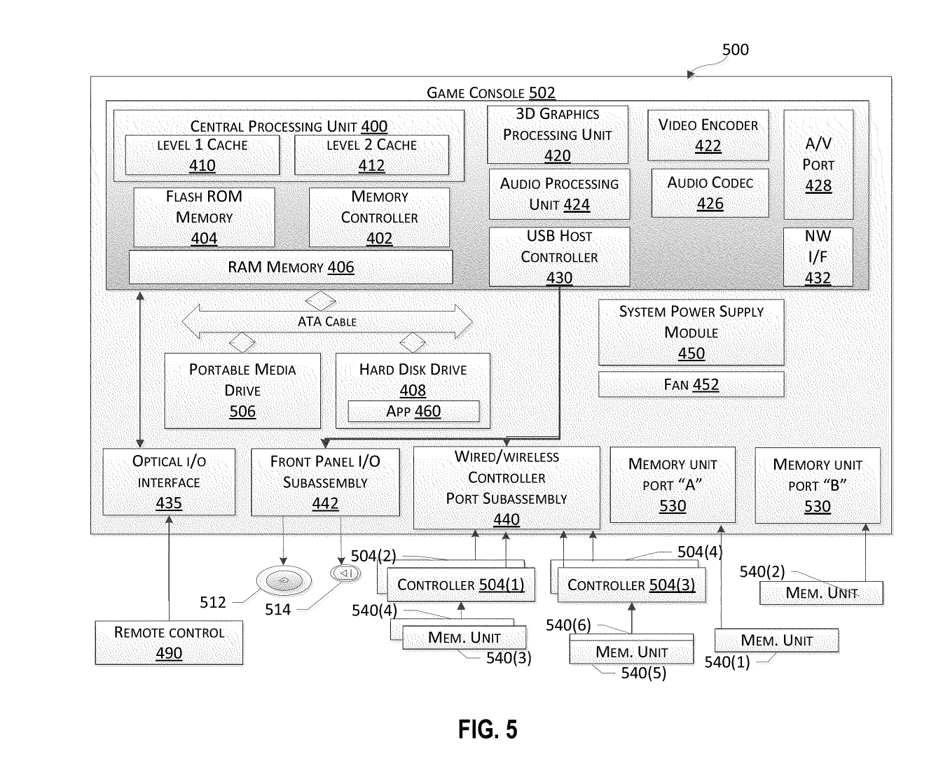

Illustrated in FIG. 1 are a client 110 and a content service 120. Various embodiments of the client device are presented herein in FIGS. 5 through 7. It should be understood that a plurality of different types of processing devices operating as client devices may be utilized in conjunction with the content service 120. Although only one client is shown, content service 120 may support a plurality of simultaneously connected client devices 110.

Each client 110 includes, for example, an operating system 112, input/output devices 113, a content presentation application 114, an ad module 116, and local owned user content 118. Operating system 112 generally provides a framework for implementing various applications and services within a client device 110. The operating system 112 may include a user interface 115 allowing users to interact with the applications and services provided by the operating system and supported by the operating system. These include the presentation application 114 which allows users to experience multimedia content on the client device 110. Various input/output devices 113 allow the user to interact with the content presentation application 114 and the operating system 112. As non-limiting examples, input/output devices 113 may include a keypad, a keyboard, a controller, a joystick, a mouse, a touch screen, or the like. Each client device may include or be coupled to a display such as a built in display, a television, a monitor, a high-definition television (HDTV), or the like. The input/output devices may capture image and audio data relating to one or more users and/or objects. For example, voice and gesture information relating to partial or full body movements, gestures, and speech of a user of client device 110 may be used to provide input. In one embodiment, a user of client device 110 may interact with an advertisement provided to the user based on information captured in the form of voice and gesture inputs. For example, input/output module 113 may detect a voice command from the user, e.g., “more information” or “play music.” In response to detecting the user's voice command, operating system 112 and/or application may provide a suitable response.

Each of the client devices 110 connects via a network 140 to the content service 120. The content service includes client interface 204, a user log-in service 208, a service database 212, an advertising service 122, and a content store 206. The client interface 204 may provide communications control for the connection of various clients 110 to the service 120. A client interface may comprise a user interface allowing a user to utilize a client device to interact with the content service 120 directly.

The content service 120 may provide a number of different services to each of the client devices. Content service 120 may include a collection of one or more servers that are configured to dynamically serve content to user based on user requests, user playlists, and in addition may serve targeted interactive advertisements to a user in accordance with embodiments of the present disclosure. Network 140 may be implemented as the internet, or other WAN, LAN, intranet, extranet, private network, or other network or networks. Other arrangements and elements (e.g., machines, interfaces, functions, orders, groupings of functions, etc.) can be used in addition to or instead of those shown. Further, many of the elements described herein are a functional entity that may be implemented as discreet or distributed components or in conjunction with other components and in any suitable combination and location. Various functions described herein as being performed by one or more entities may be carried out by hardware, firmware, and/or software. For instance, various functions may be carried out by a processor executing instructions stored in memory.

Content service 120 may include a user login service 208 which is used to authenticate a user and client devices coupled to the content service 120. During login, login service 208 obtains an identifier associated with the user or client device and a password for the user as well as a console identifier that identifies the client that the user is operating. The user is authenticated by comparing identifiers and passwords to the user account records 210 in database 212. Service database 212 can include user account records 210 which may include additional information about the user such as user owned content 214.

User owned content 214 may be content which has been purchased by the user, a record of which is maintained by the service database. In one embodiment, when user owned content 214 is purchased from, for example, a content service store 206, the content can be downloaded and stored in locally owned user content 118 on the client 110. Alternatively, the records 214 maintained in service database 212 may allow different clients owned by the user to connect to the content service 120, and stream or alternatively retrieve the user owned content 214 on different devices, depending on the licensing restrictions of the content owner and the content service 120. Portions of the user records 210 can be stored on an individual client 110, and database 212 or both.

Content management service 120 may also include a content store 206 which can be used by client devices 110 to access content provided by content sources 215. Content sources 215 may include third parties that also provide audio and visual (and audio/visual) content for use on client devices. Content sources may provide scheduling information to an advertising service 122 and/or advertisers 216 allowing advertisement targeting to coincide with content provided by the content sources. Content advertising may be scheduled by the advertising module 116 in accordance with the description provided herein. It should be understood that in one embodiment, content sources 215 may include audio media providers and video media providers. Content sources may also include game developers, broadcast media providers, and streaming or on demand media providers. Using a content store 206, users on client devices 110 may purchase, rent, and otherwise acquire content for use on the client devices, with the content provided by content sources provided to the clients through the content management service 120. Advertising service 122 allows advertisers 216 to direct advertising to users on client devices 110. In this context, advertisers 216 may create specific advertising to be associated with different types of media. Scheduling of the media is provided by an advertising scheduler 124 which cues up different types of ads, based on the scheduling and/or campaign provided by the advertiser. Advertising data 126 allows the advertising service 122 to download advertisements to clients 110, or, in an alternative embodiment, provide a resource locater for advertising data 126 stored on the content service 120, which can then be streamed to the client 110 as needed.

The function of the ad module 116 includes determining when to present advertising relative to whether content is user owned and whether a user is “present” on the device. Ad module 116 controls the presentation of advertisement in conjunction with the content presentation application 114. Local owned content 118 may comprise any of a number of different types of formats of multimedia which can be presented to the user upon the user's request.

Content presentation application 114 allows users to both: (1) select individual media to be played by, for example, clicking a user interface for the content presentation application which includes a “play” command, or (2) build a playlist, such as that illustrated in FIG. 4. The playlist lists a sequence of content events which the user wishes to consume in sequence. (Playlists can also be randomized and/or repeated.) FIG. 4 illustrates the embodiment of a playlist wherein both types of items are added to a content presentation application such as application 114 illustrated in FIG. 1. The content presentation application such as that illustrated in FIG. 1 can be an audio player, a video player, or a player capable of rendering both audio and visual content, and which is capable of connecting to a content service 120 via a network 140.

In yet another alternative, content presentation application 114 may include, for example, an automatic play sequence or disk-jockey (“DJ”). Various types of automatic content presentation algorithms may be utilized to present a “DJ” service. A DJ service will select content from both the user's owned content and the user's ad supported content to present to the user in accordance with some algorithm of theme. In yet another alternative, the content presentation application may present editorial or curated lists of content from any number of sources, including social media friends, publishers or any third party.

When a user is actively interfacing with the content presentation application 114 such as, for example, by manually selecting content, and selecting to play the content using the interface, the user is more susceptible to viewing a video advertisement than when the user builds a playlist and allows the playlist to present content in a the list sequence. When a user builds a playlist or engages a “DJ” function, the user may be a more passive consumer of the content from the content presentation application 114. With a user of the passive consumer of content, video advertising is less likely to be effective since the user may not be viewing or directly engaged with a client 110.

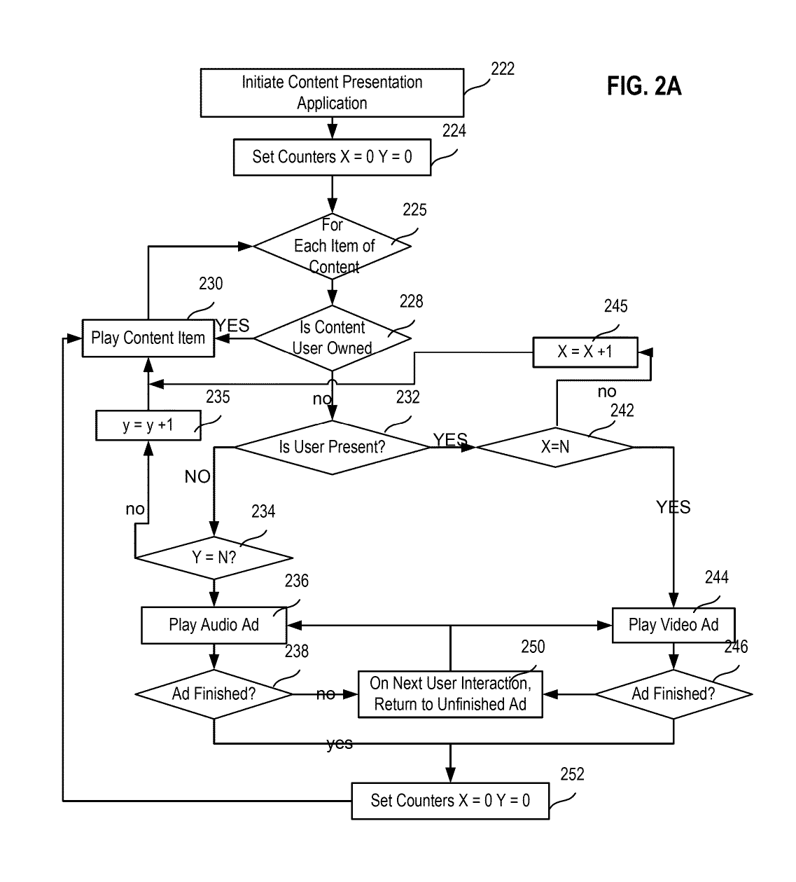

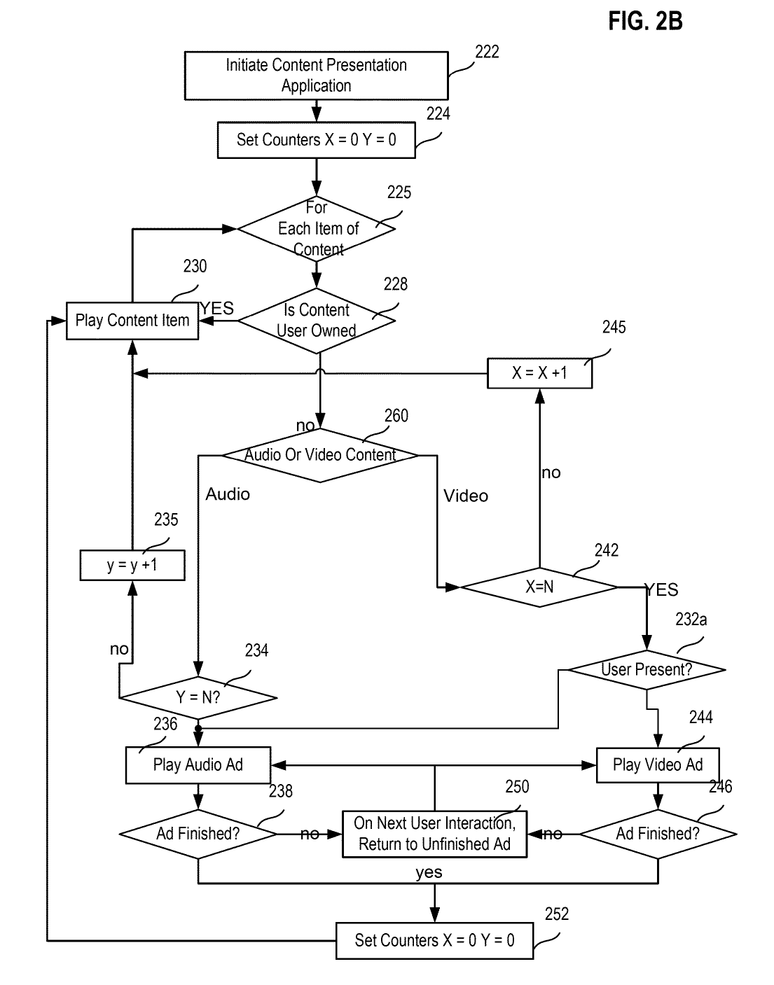

In accordance with the technology, the content presentation application 114 utilizes a method illustrated in FIGS. 2 and 3A-3B to ensure that a user is engaged with a client device and consuming content before presenting a video advertisement. In a further aspect, the content presentation application 114 presents advertising when the user is about to consume ad supported content, and not when the application is about to present user-owned content. In this manner, a user can build an entirely user-owned playlist using the content presentation application 114, and not hear an advertisement. Conversely, a hybrid playlist including both user owned and ad supported content, would present advertising to a user which is a function of the amount of ad supported versus user owned content in the playlist. In a further aspect, if a user builds a playlist and allows the playlist to run, a user would rarely see video supported content. Conversely if a user is actively selecting and starting each piece of content, the user would more frequently see video advertisement.

FIG. 2A illustrates the method of presenting content to the user in accordance with the above description. When the content presentation application is initiated by a user at 222, initially two counters, referred to herein as “X” and “Y” are set to zero at 224. Each counter is incremented as an advertising supported piece of content is played. For each item of content played at 225, as a next content item is readied for performance at 228, a determination is made at 228 as to whether or not the content is user owned or ad supported. If the next content is user owned, then at 230 the next content is presented and the application waits for the next item of content at 225. If the content is not user owned, then at 232 a determination is made as to whether or not the user is present and interacting with the content presentation application 114. Whether the user is “present” may comprise, for example, determining whether a user initiated a content play action. If so, then it can be assumed that the user is present and interacting with the application 114. Alternatively, whether the user is “present” can be ascertained from input/output devices such as web cams, and motion/detection sensors such as the Microsoft Kinect® interface device, which can detect whether a user is present, proximate, near or in front of the client device 110. Still further, whether the user is “present” can be ascertained from if the user is acting with the user interface by, for example, interacting with other input/output devices detectable by keyboard, mice and other i/o events. In each instance, it can be determined that the user is present with the client 110.

If the user is determined not to be present at 232, then at 234 the audio ad counter “Y” checks to determine whether a threshold number of plays of non-ad supported content has occurred in order to initiate the playing of an audio ad at 236. The threshold number “N” can be any number selected by the advertiser or content service provider of the content service 120. It should be further understood that the threshold number N could be the same for both the audio counter at step 234 and the video counter at 242 or different for each type of advertisement. If the threshold is not met at 234, then the counter is incremented at 235 and the content is played without an advertisement at 230. If the threshold is met at 234, then an audio ad is played at 236 and a determination made at 238 to ensure that the ad finishes playing. As will be discussed below, if an ad is interrupted prior to being finished, various scenarios may occur.

If the user is present at 232, then the video ad counter “X” is checked at 242 to determine whether a threshold number of video ad counts “N” has been made. If a threshold number of plays has not been made, then the video ad counter is incremented at 245 and the method will return to play the content at 230 without any advertisement. If the threshold video counter is met at 242, then the video ad would be played at 244 until the ad is finished as determined at 246. Once the advertising has completed at either step 238 or 246, both counters X and Y are reset to zero at 252, and after completion of the advertisement, the advertising supported content is played at 230. In this manner, audio and visual advertising are presented to a user only for content which is not owned by the user, and only when the user is engaged with the content.

As such, advertising presentation only occurs for content which is not owned by the user and only after some number of ad supported content items has played. A bias toward video advertising is provided when a user is active on the client device, and toward audio content when a playlist is operating or the user is otherwise passively consuming content.

Steps 238 and 246 in conjunction with step 250 ensure that an advertisement is completed before a user is allowed to continue playing additional ad supported content. If, for example, an ad is interrupted at either step 238 or step 246, then, at step 250, on the next user interaction, the user will be returned to the unfinished ad before the counters will be reset and any additional ad supported content will be allowed to play at 230. Advertising can be interrupted in various ways by the user. In one example, the user can close the application. In another example, a user can select a user-owned piece of content while the advertisement is playing. If a user chooses to skip through an ad and select a different, user owned piece of content, the skipping activity will allow the user to play their own content without hearing the completion of the ad, but will require the ad before the next ad supported play, and ensure that the ad is played prior to the next non-user owned content being provided.

FIG. 2B illustrates an alternative to the method illustrated in FIG. 2A. Like numbers represent like steps in both embodiments, and an explanation of similar steps having identical numbers will not be repeated. In the embodiment of FIG. 2B, after a next content item for presentation is presented at 228, a determination is made at 260 as to whether the item is audio or video (or audio/visual) content at 260. If the item is audio content, the method proceeds as in FIG. 2A at 234. If the next content item is video content at 260, then at 242 a determination is made as to whether a threshold number of items is present for presentation of a video ad. If so, then at 232a, a determination is made as to whether a user is present. If the user is not present at 232a, then at 236, an audio ad is presented. If a user is present, then a video ad is performed at 244.

Advertising is prepared for consumption as soon as counters X and Y near a play indicator. FIG. 3A represents one embodiment of step 225 in FIG. 2 where, at 302, if a playlist or DJ service is active, a determination is made at 304 to ascertain whether one or both counters X or Y are near the threshold for a next advertisement presentation. If so, then the next advertisement needed is determined at 306 and advertisement retrieved at 308 and queued for presentation at 310. If a playlist or DJ is not active at 302, the method waits for a user selection at 312.

One exception to forcing the user to review an advertisement when a counter would otherwise require viewing is illustrated in FIG. 3B. FIG. 3b illustrates a method for playing an audio or a visual ad when an edge case occurs. An edge case may be a determination by the provider of the content service 120 that it would not be advantageous to the service to play an advertisement under certain situations.

In FIG. 3B, if a playlist or DJ is active in selecting songs at 322, a determination is made as to whether or not the audio ad is part of an edge case where a playlist or DJ is previously interrupted. If so, then ad play may be skipped at 326 and for an ad counter which should have played, and the ad count may be set and subtracted by one at 328. An edge case as defined in step 322 may include, for example, a user definition of a playlist which is suspended during the middle of play. Where, for example, a user initiates a playlist, and the ad count reaches a state where the next piece of content in the playlist would have comprised an ad supported piece of content which would have generated performance of an ad prior to displaying the content, and where the user has suspended play and left the playlist for a threshold period of time, an edge case may be defined such that step 306 and 308 occur. This ensures that a user who walks away from a playlist for a significant amount of time is not presented with an advertisement as the first experience the user hears or sees when consuming new content. Such could have a deleterious effect on the user's use of application 114.

FIG. 4 is a functional block diagram of gaming and media system 500 and shows functional components of gaming and media system 500 in more detail. Console 502 has a central processing unit (CPU) 400, and a memory controller 402 that facilitates processor access to various types of memory, including a flash Read Only Memory (ROM) 404, a Random Access Memory (RAM) 406, a hard disk drive 408, and portable media drive 506. In one implementation, CPU 400 includes a level 5 cache 410 and a level 4 cache 412, to temporarily store data and hence reduce the number of memory access cycles made to the hard drive 408, thereby improving processing speed and throughput.

CPU 400, memory controller 402, and various memory devices are interconnected via one or more buses (not shown). The details of the bus that is used in this implementation are not particularly relevant to understanding the subject matter of interest being discussed herein. However, it will be understood that such a bus might include one or more of serial and parallel buses, a memory bus, a peripheral bus, and a processor or local bus, using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

In one implementation, CPU 400, memory controller 402, ROM 404, and RAM 406 are integrated onto a common module 414. In this implementation, ROM 404 is configured as a flash ROM that is connected to memory controller 402 via a PCI bus and a ROM bus (neither of which are shown). RAM 406 is configured as multiple Double Data Rate Synchronous Dynamic RAM (DDR SDRAM) modules that are independently controlled by memory controller 402 via separate buses (not shown). Hard disk drive 408 and portable media drive 506 are shown connected to the memory controller 402 via the PCI bus and an AT Attachment (ATA) bus 416. However, in other implementations, dedicated data bus structures of different types can also be applied in the alternative.

A three-dimensional graphics processing unit 420 and a video encoder 422 form a video processing pipeline for high speed and high resolution (e.g., High Definition) graphics processing. Data are carried from graphics processing unit 420 to video encoder 422 via a digital video bus (not shown). An audio processing unit 424 and an audio codec (coder/decoder) 426 form a corresponding audio processing pipeline for multi-channel audio processing of various digital audio formats. Audio data are carried between audio processing unit 424 and audio codec 426 via a communication link (not shown). The video and audio processing pipelines output data to an NV (audio/video) port 428 for transmission to a television or other display. In the illustrated implementation, video and audio processing components 420-228 are mounted on module 414.

FIG. 5 shows module 414 including a USB host controller 430 and a network interface 432. USB host controller 430 is shown in communication with CPU 400 and memory controller 402 via a bus (e.g., PCI bus) and serves as host for peripheral controllers 504(1)-104(4). Network interface 432 provides access to a network (e.g., Internet, home network, etc.) and may be any of a wide variety of various wire or wireless interface components including an Ethernet card, a modem, a wireless access card, a Bluetooth module, a cable modem, and the like.

In the implementation depicted in FIG. 4, console 502 includes a controller support subassembly 440 for supporting four controllers 504(1)-104(4). The controller support subassembly 440 includes any hardware and software components to support wired and wireless operation with an external control device, such as for example, a media and game controller. A front panel I/O subassembly 442 supports the multiple functionalities of power button 512, the eject button 514, as well as any LEDs (light emitting diodes) or other indicators exposed on the outer surface of console 502. Subassemblies 440 and 442 are in communication with module 414 via one or more cable assemblies 444. In other implementations, console 502 can include additional controller subassemblies. The illustrated implementation also shows an optical I/O interface 435 that is configured to send and receive signals that can be communicated to module 414.

MUs 540(1) and 540(2) are illustrated as being connectable to MU ports “A” 530(1) and “B” 530(2) respectively. Additional MUs (e.g., MUs 540(3)-140(6)) are illustrated as being connectable to controllers 504(1) and 504(3), i.e., two MUs for each controller. Controllers 504(2) and 504(4) can also be configured to receive MUs (not shown). Each MU 540 offers additional storage on which games, game parameters, and other data may be stored. In some implementations, the other data can include any of a digital game component, an executable gaming application, an instruction set for expanding a gaming application, and a media file. When inserted into console 502 or a controller, MU 540 can be accessed by memory controller 402.

A system power supply module 450 provides power to the components of gaming system 500. A fan 452 cools the circuitry within console 502.

An application 460 comprising machine instructions is stored on hard disk drive 408. When console 502 is powered on, various portions of application 460 are loaded into RAM 406, and/or caches 410 and 412, for execution on CPU 400, wherein application 460 is one such example. Various applications can be stored on hard disk drive 408 for execution on CPU 400.

Gaming and media system 500 may be operated as a standalone system by simply connecting the system to monitor 550 (FIG. 5), a television, a video projector, or other display device. In this standalone mode, gaming and media system 500 enables one or more players to play games, or enjoy digital media, e.g., by watching movies, or listening to music. However, with the integration of broadband connectivity made available through network interface 432, gaming and media system 500 may further be operated as a participant in a larger network gaming community, as discussed below in connection with FIG. 3.

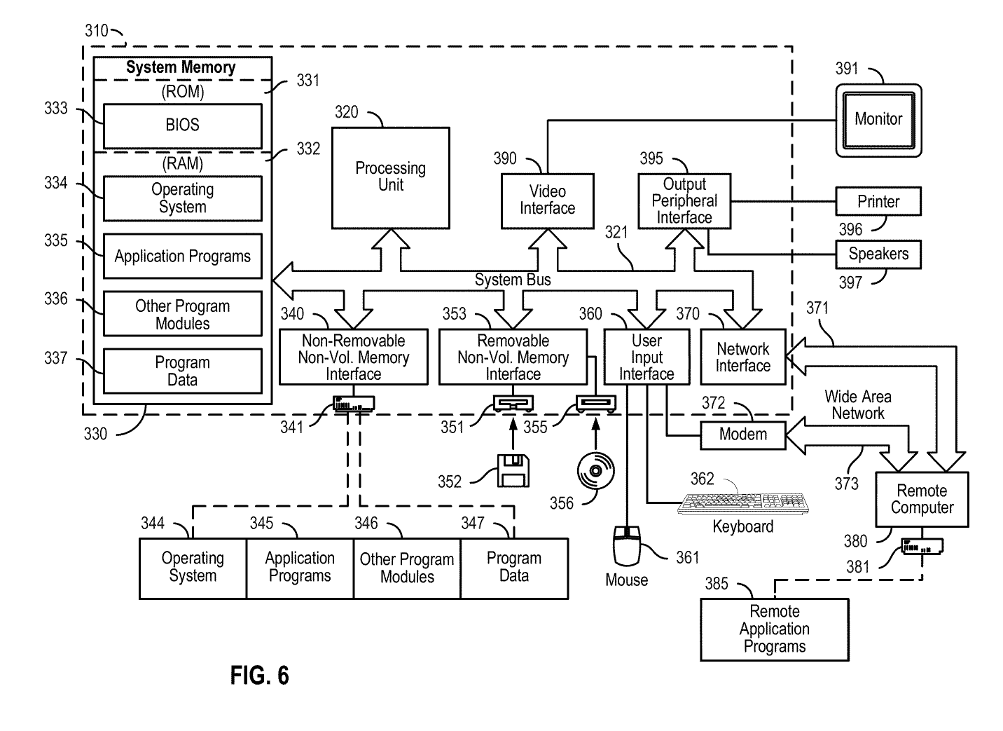

FIG. 6 illustrates an example of a computing device for implementing the present technology. In one embodiment, the computing device of FIG. 6 provides more detail for client device 110 and content management service 120 of FIG. 1. The computing environment of FIG. 6 is one example of a suitable computing environment and is not intended to suggest any limitation as to the scope of use or functionality of the present technology. Neither should the computing environment be interpreted as having any dependent requirement relating to any one or combination of components illustrated in the exemplary operating environment.

The present technology is operational in numerous other general purpose or special computing system environments or configurations. Examples of well known computing systems, environments, and/or configurations that may be suitable for implementing the present technology include, but are not limited to personal computers, server computers, laptop devices, multiprocessor systems, microprocessor-based systems, network PCs, minicomputers, mainframe computers, distributed computing environments that include any of the above systems or the like.

The present technology may be described in the general context of computer-executable instructions, such as program modules, being executed by a computer. Generally, program modules include routines, programs, objects, components, data structures, etc. that perform a particular task or implement particular abstract data types. The present technology may be also practiced in distributed computing environments where tasks are performed by remote processing devices that are linked through a communications network. In a distributed computing environment, program modules may be located in both local and remote computer storage media including memory storage devices.

With reference to FIG. 6, an exemplary system for implementing the technology herein includes a general purpose computing device in the form of a computer 310. Components of computer 310 may include, but are not limited to, a processing unit 320, a system memory 330, and a system bus 321 that couples various system components including system memory 330 to processing unit 320. System bus 321 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 310 typically includes a variety of computer readable media. Computer readable media can be any available media that can be accessed by computer 310 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 310.

System memory 330 includes computer storage media in the form of volatile and/or nonvolatile memory such as read only memory (ROM) 331 and random access memory (RAM) 332. A basic input/output system 333 (BIOS), containing the basic routines that help to transfer information between elements within computer 310, such as during start-up, is typically stored in ROM 331. RAM 332 typically contains data and/or program modules that are immediately accessible to and/or presently being operated on by processing unit 320. By way of example, and not limitation, FIG. 12 illustrates operating system 334, application programs 335, other program modules 336, and program data 337.

Computer 310 may also include other removable/non-removable, volatile/nonvolatile computer storage media. By way of example only, FIG. 12 illustrates a hard disk drive 341 that reads from or writes to non-removable, nonvolatile magnetic media, a magnetic disk drive 351 that reads from or writes to a removable, nonvolatile magnetic disk 352, and an optical disk drive 355 that reads from or writes to a removable, nonvolatile optical disk 356 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. Hard disk drive 341 is typically connected to system bus 321 through a non-removable memory interface such as interface 340, and magnetic disk drive 351 and optical disk drive 355 are typically connected to system bus 321 by a removable memory interface, such as interface 353.

The drives and their associated computer storage media discussed above and illustrated in FIG. 6 provide storage of computer readable instructions, data structures, program modules and other data for computer 310. In FIG. 6, for example, hard disk drive 341 is illustrated as storing operating system 344, application programs 345, other program modules 346, and program data 347. Note that these components can either be the same as or different from operating system 334, application programs 335, other program modules 336, and program data 337. Operating system 344, application programs 345, other program modules 346, and program data 347 are given different numbers here to illustrate that, at a minimum, they are different copies. A user may enter commands and information into computer 310 through input devices such as a keyboard 362 and pointing device 361, commonly referred to as a mouse, trackball or touch pad. Other input devices (not shown) may include a camera, depth capture device, microphone, joystick, game pad, satellite dish, scanner, or the like. These and other input devices are often connected to the processing unit 320 through a user input interface 360 that is coupled to the system bus, but may be connected by other interface and bus structures, such as a parallel port, game port or a universal serial bus (USB). A monitor 391 or other type of display device is also connected to system bus 321 via an interface, such as a video interface 390. In addition to the monitor, computers may also include other peripheral output devices such as speakers 397 and printer 396, which may be connected through an output peripheral interface 390.

Computer 310 may operate in a networked environment using logical connections to one or more remote computers, such as a remote computer 380. Remote computer 380 may be a personal computer, a server, a router, a network PC, a peer device or other common network node, and typically includes many or all of the elements described above relative to computer 310, although only a memory storage device 381 has been illustrated in FIG. 6. The logical connections depicted in FIG. 6 include a local area network (LAN) 371 and a wide area network (WAN) 373, but may also include other networks. Such networking environments are commonplace in offices, enterprise-wide computer networks, intranets and the Internet.

When used in a LAN networking environment, computer 310 is connected to LAN 371 through a network interface or adapter 370. When used in a WAN networking environment, computer 310 typically includes a modem 372 or other means for establishing communications over WAN 373, such as the Internet. Modem 372, which may be internal or external, may be connected to system bus 321 via user input interface 360, or other appropriate mechanism. In a networked environment, program modules depicted relative to computer 310, or portions thereof, may be stored in the remote memory storage device. By way of example, and not limitation, FIG. 6 illustrates remote application programs 385 as residing on memory device 381. It will be appreciated that the network connections shown are exemplary and other means of establishing a communications link between the computers may be used.

Those skilled in the art will understand that program modules such as operating system 334, application programs 345, and data 337 are provided to computer 310 via one of its memory storage devices, which may include ROM 331, RAM 332, hard disk drive 341, magnetic disk drive 351, or optical disk drive 355. Hard disk drive 341 is used to store data 337 and the programs, including operating system 334 and application programs 345.

When computer 310 is turned on or reset, BIOS 333, which is stored in ROM 331 instructs processing unit 320 to load operating system 334 from hard disk drive 341 into RAM 332. Once operating system 334 is loaded into RAM 332, processing unit 320 executes the operating system code and causes the visual elements associated with the user interface of the operating system to be displayed on the monitor. When a user opens an application program 345, the program code and relevant data are read from hard disk drive 341 and stored in RAM 332.

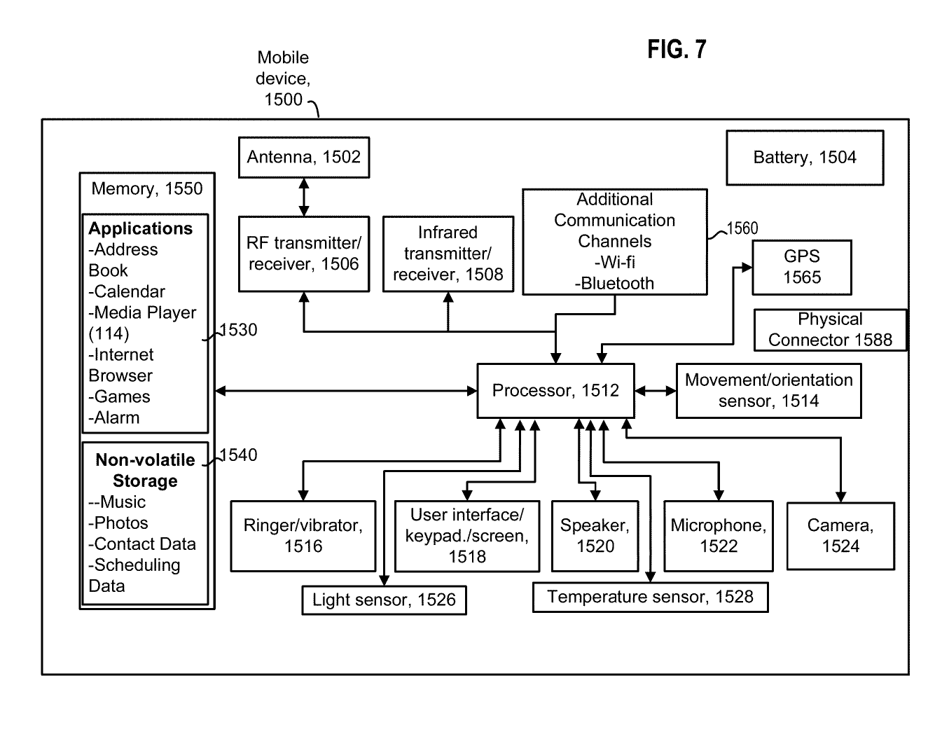

FIG. 7 is a block diagram of an exemplary tablet computing device or other mobile device which may operate in embodiments of the technology described herein. Exemplary electronic circuitry of a typical mobile phone is depicted. The device 1500 includes one or more microprocessors 1512, and memory 1510 (e.g., non-volatile memory such as ROM and volatile memory such as RAM) which stores processor-readable code which is executed by one or more processors of the control processor 1512 to implement the functionality described herein.

Mobile device 1500 may include, for example, processors 1512, memory 1550 including applications and non-volatile storage. The processor 1512 can implement communications, as well as any number of applications, including the interaction applications discussed herein. Memory 1550 can be any variety of memory storage media types, including non-volatile and volatile memory. A device operating system handles the different operations of the mobile device 1500 and may contain user interfaces for operations, such as placing and receiving phone calls, text messaging, checking voicemail, and the like. The applications 1530 can be any assortment of programs, such as a camera application for photos and/or videos, an address book, a calendar application, a media player, an Internet browser, games, other multimedia applications, an alarm application, other third party applications, the interaction application discussed herein, and the like. The non-volatile storage component 1540 in memory 1510 contains data such as web caches, music, photos, contact data, scheduling data, and other files.

The processor 1512 also communicates with RF transmit/receive circuitry 1506 which in turn is coupled to an antenna 1502, with an infrared transmitted/receiver 1508, with any additional communication channels 1560 like Wi-Fi or Bluetooth, and with a movement/orientation sensor 1514 such as an accelerometer. Accelerometers have been incorporated into mobile devices to enable such applications as intelligent user interfaces that let users input commands through gestures, indoor GPS functionality which calculates the movement and direction of the device after contact is broken with a GPS satellite, and to detect the orientation of the device and automatically change the display from portrait to landscape when the phone is rotated. An accelerometer can be provided, e.g., by a micro-electromechanical system (MEMS) which is a tiny mechanical device (of micrometer dimensions) built onto a semiconductor chip. Acceleration direction, as well as orientation, vibration and shock can be sensed. The processor 1512 further communicates with a ringer/vibrator 1516, a user interface keypad/screen, biometric sensor system 1518, a speaker 1520, a microphone 1522, a camera 1524, a light sensor 1526 and a temperature sensor 1528.

The processor 1512 controls transmission and reception of wireless signals. During a transmission mode, the processor 1512 provides a voice signal from microphone 1522, or other data signal, to the RF transmit/receive circuitry 1506. The transmit/receive circuitry 1506 transmits the signal to a remote station (e.g., a fixed station, operator, other cellular phones, etc.) for communication through the antenna 1502. The ringer/vibrator 1516 is used to signal an incoming call, text message, calendar reminder, alarm clock reminder, or other notification to the user. During a receiving mode, the transmit/receive circuitry 1506 receives a voice or other data signal from a remote station through the antenna 1502. A received voice signal is provided to the speaker 1520 while other received data signals are also processed appropriately.

Additionally, a physical connector 1588 can be used to connect the mobile device 1500 to an external power source, such as an AC adapter or powered docking station. The physical connector 1588 can also be used as a data connection to a computing device. The data connection allows for operations such as synchronizing mobile device data with the computing data on another device.

A GPS transceiver 1565 utilizing satellite-based radio navigation to relay the position of the user applications is enabled for such service.

The example computer systems illustrated in the Figures include examples of computer readable storage media. Computer readable storage media are also processor readable storage media. Such media may include volatile and nonvolatile, removable and non-removable media implemented in any method or technology for storage of information such as computer readable instructions, data structures, program modules or other data. Computer storage media includes, but is not limited to, RAM, ROM, EEPROM, cache, flash memory or other memory technology, CD-ROM, digital versatile disks (DVD) or other optical disk storage, memory sticks or cards, magnetic cassettes, magnetic tape, a media drive, a hard disk, magnetic disk storage or other magnetic storage devices, or any other medium which can be used to store the desired information and which can accessed by a computer.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A computer implemented method of presenting user-owned and advertising supported content to a user, comprising:
receiving a selection of content items for presentation;
determining whether a next content item for presentation is an advertising supported content item or a user-owned content item;
if the next content item for presentation is a user-owned content item, presenting the content item without an advertisement;
if the next content item is an advertising supported content item, adding the content item to a count, and
after a threshold number of next content items in the count comprise advertising supported content items, presenting an advertisement prior to performing the next advertising supported content item.

2. The computer implemented method of claim 1 wherein said receiving includes a creation by the user of a playlist.

3. The computer implemented method of claim 1 wherein the receiving includes a user selection of at least one next content item.

4. The computer implemented method of claim 1 wherein the content item comprises one of an audio or video content item.

5. The computer implemented method of claim 4 wherein the advertisement is one of an audio advertisement or a video advertisement, said advertisement comprising an audio advertisement when the next content items is an audio content item, said advertisement comprising a video advertisement when the next content item is a video content item.

6. The computer implemented method of claim 5 wherein the presenting comprises, prior to presenting a video advertisement, detecting presence of a user before a presentation device and if no user is present, reducing the count.

7. The computer implement method of claim 1 wherein presenting further includes detecting if the advertisement has completed prior to performing the next advertising supported content item.

8. The computer implemented method of claim 7 further comprising:
detecting if an advertisement is interrupted prior to completion, and if so, upon a request to resume performance of a content item, if the count is above the threshold, reducing the count by one and performing the next advertising supported content item.

9. A media performance apparatus, comprising:
an audio/visual output;
a processor presenting user-owned and advertising supported content to the output;
a memory including code instructing the processor to present items of user owned content and advertising supported content to the audio/visual output, the code instructing the processor to:
determine whether a next content item for presentation is an advertising supported content item or a user-owned content item;
present the content item if the next content item for presentation is a user-owned content item,
add to a count if the next content item is an advertising supported content item, and
present an advertisement prior to performing any next advertising supported content item when the count reaches a threshold number.

10. The media performance apparatus of claim 9 wherein each of the advertising supported content items and the user owned content items may be audio content or audio/video content.

11. The media performance apparatus of claim 9 wherein said code to determine a next content item includes determining a next item in a user playlist.

12. The media performance apparatus of claim 9 wherein said code to determine a next content item includes receiving a user selection of at least one next content item.

13. The media performance apparatus of claim 9 wherein the advertisement is one of an audio advertisement or a video advertisement.

14. The media performance apparatus of claim 13 wherein the apparatus includes at least one input/output device, and the processor includes code instructing the processor to detect presence of a user before proximate the apparatus and if no user is present, reduce the count.

15. The media performance apparatus of claim 14 wherein presenting further includes detecting if the advertisement has completed prior to performing the next advertising supported content item.

16. The media performance apparatus of claim 15 further comprising detecting if an advertisement is interrupted prior to completion, and if so, upon a request to resume performance of a content item, if the count is above the threshold, reducing the count by one and performing the next advertising supported content item.

17. A method of presenting user-owned and advertising supported content to a user on a content presentation device, comprising:
providing a selection of user owned content items and advertising supported content items;
receiving a selection of user owned content items and advertising supported content items, the selection having an order;
determining whether a user is present at the content presentation device;
determining to present an advertisement;
if the next content item for presentation is an advertising supported content item and the user is present, presenting an video advertisement prior to performing the next advertising content item; and
if the user is not present, presenting an audio content item.

18. The method of claim 17 wherein the step of determining to present an advertisement comprises:
determining whether a next content item in the order for presentation is an advertising supported content item or a user-owned content item;
if the next content item for presentation is a user-owned content item, determining not to present an advertisement;
if the next content item is an advertising supported content item, adding the content item to a count, and after a threshold number of next content items in the count comprise advertising supported content items, determining to present an advertisement.

19. The method of claim 18 wherein the content items comprise any of an audio, video or audio/visual content item.

20. The method of claim 19 wherein the method further includes detecting if an advertisement is interrupted prior to completion, and if so, upon a request to resume performance of a content item, if the count is above the threshold, reducing the count by one and performing the next advertising supported content item.
